(19) United States
(12) Patent Application Publication
(10) Pub. No.: US 2023/0287019 A1
(43) Pub. Date: Sep. 14, 2023

(54) METHOD OF MANUFACTURING ALKOXYSILANE COMPOUND

(71) Applicant: LG CHEM, LTD., Seoul (KR)

(72) Inventors: Kyu Reon LEE, Daejeon (KR); Se Won BAEK, Daejeon (KR)

(21) Appl. No.: 18/018,092

(22) PCT Filed: Jul. 30, 2021
(86) PCT No.: PCT/KR2021/009971

§ 371 Date: Jan. 26, 2023

(30) Foreign Application Priority Data
Jul. 31, 2020 (KR) 10-2020-0096158

(51) Int. Cl. C07F 7/18

(52) U.S. Cl. CPC C07F 7/188

(57) ABSTRACT

Provided is a method of manufacturing an alkoxysilane compound that is capable of more effectively removing ammonia generated as a by-product when the alkoxysilane compound is manufactured using a silazane-based compound, the method including adding an alcohol to a silazane-based compound of Formula 1:

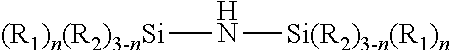

and allowing the alcohol to react with the silazane-based compound to prepare a first mixture comprising an alkoxysilane compound and ammonia; adding an alcohol and a compound of Formula 2:

(R₁)ₙ(R₂)₃₋ₙSi—X

to the first mixture and allowing the alcohol and the compound of Formula 2 to react with the first mixture to prepare a second mixture in which an additional alkoxysilane compound and an ammonium salt are generated; adding an aqueous solvent to the second mixture to dissolve the ammonium salt; and separating and removing the ammonium salt.

### CROSS-REFERENCE TO RELATED APPLICATION(S)

This application is a National Stage Application of International Application No. PCT/KR2021/009971 filed on Jul. 30, 2021, which claims priority to and the benefit of Korean Patent Application No. 10-2020-0096158, filed Jul. 31, 2020, the disclosure of which is incorporated herein by reference in its entirety.

### TECHNICAL FIELD

The present invention relates to a method of manufacturing an alkoxysilane compound, and more particularly, to a method of manufacturing an alkoxysilane compound used for hydrophobic surface modification of a silica aerogel.

### BACKGROUND

Aerogels are highly porous materials that are composed of nanoparticles, and have attracted attention for use as high-efficiency insulating materials, soundproof materials, and the like because they have high porosity, a high specific surface area, and low thermal conductivity. Because such aerogels have very low mechanical strength due to their porous structure, aerogel composites, in which an aerogel is impregnated into fibrous blankets formed of existing insulating fibers (such as organic or inorganic fibers) so that the aerogel is bound to the fibrous blankets, have been developed. As one example, a silica aerogel-containing blanket using a silica aerogel is manufactured through a silica sol preparation step, a gelation step, an aging step, a surface modification step, and a drying step.

A silazane-based compound used as a surface modifying agent in a step of surface modifying a silica aerogel and a silica aerogel-containing blanket is decomposed into an alkoxysilane compound or a silanol compound to generate a large amount of NH3. NH3 is dissolved in a solvent present in a hydrogel and can react with carbon dioxide, which is used as an extraction solvent during subsequent supercritical drying, to form ammonium carbonate salts. Then, as the temperature decreases, the ammonium carbonate salts can precipitate to form a solid-phase powder, which causes problems such as scale formation, pipe or valve clogging, or the like in subsequent processes.

Therefore, it has been preferred to use an alkoxysilane compound, which does not generate ammonia, instead of a silazane-based compound, as the surface modifying agent in the step of surface modifying a silica aerogel or a silica aerogel-containing blanket. Accordingly, there is a need for a novel method of manufacturing an alkoxysilane compound capable of more effectively removing ammonia generated as a by-product when an alkoxysilane compound is manufactured using the silazane-based compound.

### PRIOR ART DOCUMENT

### Patent Document

(Patent Document 1) Korean Patent Publication No. 10-2016-0100082

### BRIEF DESCRIPTION

### Technical Problem

Therefore, it is an object of the present invention to provide a novel method of manufacturing an alkoxysilane compound capable of more effectively removing ammonia generated as a by-product during a process of manufacturing an alkoxysilane compound using a silazane-based compound.

### Technical Solution

To achieve the above object, according to one aspect of the present invention, there is provided a method of manufacturing an alkoxysilane compound, which includes: (1) adding an alcohol to a silazane-based compound of the following Formula 1 and allowing the alcohol to react with the silazane-based compound to prepare a first mixture including an alkoxysilane compound and ammonia; (2) adding an alcohol and a compound of the following Formula 2 to the first mixture and allowing the alcohol and the compound of Formula 2 to react with the first mixture to prepare a second mixture in which an additional alkoxysilane compound and an ammonium salt are generated; (3) adding an aqueous solvent to the second mixture to dissolve the ammonium salt; and (4) separating and removing an aqueous layer in which the ammonium salt is dissolved in order to obtain an alkoxysilane compound:

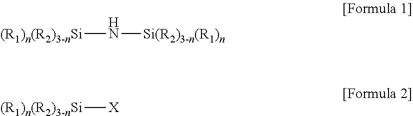

wherein R₁ is an alkyl group having 1 to 8 carbon atoms, R₂ is a hydrogen atom or an alkyl group having 1 to 8 carbon atoms, n is an integer ranging from 1 to 3, and X is Cl or Br.

### Advantageous Effects

The method of manufacturing an alkoxysilane compound according to the present invention can have an effect of enhancing a yield of an alkoxysilane compound to be manufactured while effectively removing ammonia formed as a by-product during a process of manufacturing an alkoxysilane compound using a silazane-based compound by manufacturing an additional alkoxysilane compound using ammonia and simultaneously converting the ammonia into an ammonium salt.

### DETAILED DESCRIPTION

Hereinafter, the present invention will be described in further detail in order to aid in understanding the present invention.

The terms and words used in this specification and the appended claims are not intended to be construed as having common and dictionary meanings but are construed as having meanings and concepts corresponding to the technical spirit of the present invention in view of the principle that the present inventors can properly define the concepts of the terms and words in order to describe his/her invention in the best way.

A method of manufacturing an alkoxysilane compound according to the present invention includes: (1) adding an alcohol to a silazane-based compound of the following Formula 1 and allowing the alcohol to react with the silazane-based compound to prepare a first mixture including an alkoxysilane compound and ammonia; (2) adding an alcohol and a compound of the following Formula 2 to the first mixture and allowing the alcohol and the compound of Formula 2 to react with the first mixture to prepare a second mixture in which an additional alkoxysilane compound and an ammonium salt are generated; (3) adding an aqueous solvent to the second mixture to dissolve the ammonium salt; and (4) separating and removing an aqueous layer in which the ammonium salt is dissolved in order to obtain an alkoxysilane compound:

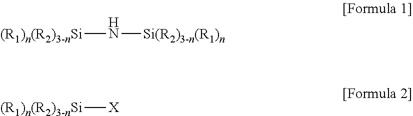

wherein R₁ is an alkyl group having 1 to 8 carbon atoms, R₂ is a hydrogen atom or an alkyl group having 1 to 8 carbon atoms, n is an integer ranging from 1 to 3, and X is Cl or Br.

(1) Adding Alcohol to Silazane-Based Compound of Formula 1 and Allowing Alcohol to React with Silazane-Based Compound to Prepare First Mixture Including Alkoxysilane Compound and Ammonia

In Step (1), an alcohol is added and reacted with a silazane-based compound of the following Formula 1 to synthesize an alkoxysilane compound. In this case, a first mixture including an alkoxysilane compound and ammonia is prepared while ammonia is generated as a by-product:

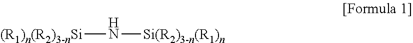

wherein R₁ is an alkyl group having 1 to 8 carbon atoms, R₂ is a hydrogen atom or an alkyl group having 1 to 8 carbon atoms, and n is an integer ranging from 1 to 3.

Also, R₁ can be an alkyl group having 1 to 6 carbon atoms, and R₂ can be a hydrogen atom or an alkyl group having 1 to 6 carbon atoms.

In addition, R₁ can be an alkyl group having 1 to 4 carbon atoms, and R₂ can be a hydrogen atom or an alkyl group having 1 to 4 carbon atoms.

According to one embodiment of the present invention, the silazane-based compound can include one or more selected from the group consisting of a dialkyldisilazane, a tetraalkyldisilazane, and a hexaalkyldisilazane.

Also, specific examples of the silazane-based compound can include 1,3-diethyldisilazane, 1,1,3,3-tetramethyl-disilazane, 1,1,3,3-tetraethyldisilazane, 1,1,1,3,3,3-hexamethyldisilazane (HMDS), 1,1,1,3,3,3-hexaethyl-disilazane, 1,1,3,3-tetraethyldisilazane, 1,3-diisopropyldisilazane, or the like, which can be used alone or as a mixture thereof.

Meanwhile, examples of the alcohol can include monohydric alcohols such as methanol, ethanol, propanol, isopropanol, butanol, pentanol, hexanol, heptanol, octanol, and the like, dihydric alcohols such as glycerol, ethylene glycol, dipropylene glycol, and the like, which can be used alone or as a mixture thereof. According to one embodiment of the present invention, the alcohol can include one or more selected from the group consisting of methanol, ethanol, propanol, isopropanol, butanol, pentanol, hexanol, heptanol, octanol, glycerol, ethylene glycol, and dipropylene glycol. Specifically, the alcohol can include one or more selected from the group consisting of methanol, ethanol, propanol, isopropanol, butanol, pentanol, and hexanol. More specifically, the alcohol can include one or more selected from the group consisting of methanol, ethanol, propanol, isopropanol, and butanol.

The alkoxysilane compound synthesized by adding the alcohol to the silazane-based compound of Formula 1 and allowing the alcohol to react with the silazane-based compound can include one or more selected from the group consisting of a monoalkoxysilane compound, a dialkoxysilane compound, and a trialkoxysilane compound. When the alcohol is a compound of the following Formula 3, the alkoxysilane compound can be specifically a compound of the following Formula 4:

R₃OH [Formula 3]

(R₁)ₙ(R₂)₃₋ₙSi—O—R [Formula 4]

wherein R₁ and R₃ are each independently an alkyl group having 1 to 8 carbon atoms, R₂ is a hydrogen atom or an alkyl group having 1 to 8 carbon atoms, and n is an integer ranging from 1 to 3.

Also, R₁ and R₃ can be each independently an alkyl group having 1 to 6 carbon atoms, and R₂ can be a hydrogen atom or an alkyl group having 1 to 6 carbon atoms.

In addition, R₁ and R₃ can be each independently an alkyl group having 1 to 4 carbon atoms, and R₂ can be each independently a hydrogen atom or an alkyl group having 1 to 4 carbon atoms.

The reaction of the alcohol with the silazane-based compound can be represented by the following Scheme 1. In this case, one equivalent of a silazane-based compound is reacted with 2 equivalents of an alcohol to generate 2 equivalents of an alkoxysilane compound, and one equivalent of ammonia is generated as a by-product. The first mixture thus prepared can include an alkoxysilane compound and ammonia:

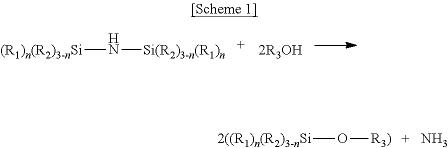

wherein R₁ to R₃ and n are as defined in Formulas 1, 3, and 4.

(2) Adding Alcohol and Compound of Formula 2 to First Mixture and Allowing Alcohol and Compound of Formula 2 to React with First Mixture to Prepare Second Mixture in which Additional Alkoxysilane Compound and Ammonium Salt are Generated

In Step (2), an alcohol and a compound of the following Formula 2 are added and reacted with the prepared first mixture to generate an additional alkoxysilane compound through a reaction of ammonia with the compound of the following Formula 2. At the same time, ammonia is converted into an ammonium salt. That is, in Step (2), an additional alkoxysilane compound is generated through a reaction of ammonia included in the first mixture with the compound of the following Formula 2, and the ammonia is simultaneously converted into an ammonium salt. Then, the ammonia converted into the ammonium salt can be removed through subsequent processes:

(R₁)ₙ(R₂)₃₋ₙS—X [Formula 2]

wherein R₁ is an alkyl group having 1 to 8 carbon atoms, R₂ is a hydrogen atom or an alkyl group having 1 to 8 carbon atoms, n is an integer ranging from 1 to 3, and X is Cl or Br.

Also, R₁ can be an alkyl group having 1 to 6 carbon atoms, and R₂ can be a hydrogen atom or an alkyl group having 1 to 6 carbon atoms.

In addition, R₁ can be an alkyl group having 1 to 4 carbon atoms, and R₂ can be a hydrogen atom or an alkyl group having 1 to 4 carbon atoms.

Further, X can be Cl.

According to one embodiment of the present invention, the alcohol used in Step (2) can be the same alcohol as used in Step (1). When the alcohol used in Step (2) is identical to the alcohol used in Step (1), the alkoxysilane compound manufactured in Step (1) can be identical to the additional alkoxysilane compound manufactured in Step (2).

The reaction of Step (2) can be represented by the following Scheme 2.

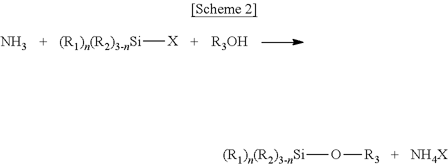

In Scheme 2, the ammonia (NH3) is generated as a result of decomposition of the silazane-based compound in Step (1) so that the ammonia is included in the first mixture. In Step (2), the alcohol and the compound of the following Formula 2 are reacted with ammonia generated as a by-product of reaction of the alcohol with the silazane-based compound to prepare a second mixture in which an additional alkoxysilane compound and an ammonium salt are generated. That is, the method of manufacturing an alkoxysilane compound according to the present invention can have an effect of converting ammonia into the form of an ammonium salt that can be easily removed and simultaneously generating an additional alkoxysilane compound using the ammonia that is, conventionally, merely a target of removal.

The compound of Formula 2 can be added at the same equivalent(s) as ammonia in the first mixture. When the compound of Formula 2 is added at an amount much lower than ammonia in the first mixture, ammonia can be not completely converted into ammonium, which results in poor ammonia removal efficiency. On the other hand, when the compound of Formula 2 is added at an amount much larger than ammonia in the first mixture, side reactions can occur, which makes it difficult to control the process.

In order to add the compound of Formula 2 at the same equivalent(s) as ammonia in the first mixture, the method of manufacturing an alkoxysilane compound according to one embodiment of the present invention further includes: measuring a concentration of ammonia included in the first mixture before introducing the compound of Formula 2 to the first mixture. For example, as shown in Step (1), after the alcohol is added and reacted with the silazane-based compound of Formula 1, a concentration of ammonia included in the first mixture can be measured. Thereafter, the compound of Formula 2 can be added at the same equivalent(s) based on the concentration of ammonia.

(3) Adding Aqueous Solvent to Second Mixture to Dissolve Ammonium Salt

In Step (3), an aqueous solvent is added to the second mixture to dissolve the ammonium salt converted from ammonia in Step (2). The second mixture includes an alkoxysilane compound and an ammonium salt. In this case, because the alkoxysilane compound is not dissolved in the aqueous solvent and only the ammonium salt is dissolved in the aqueous solvent, the ammonium salt can be separated into an aqueous layer.

The aqueous solvent is used to dissolve the ammonium salt converted from ammonia in Step (2). Therefore, the aqueous solvent can be used to dissolve the ammonium salt without dissolving the alkoxysilane compound. For example, the aqueous solvent can be water. In this case, the water can be process water, specifically distilled water or ion-exchanged water.

(4) Separating and Removing Aqueous Layer in which Ammonium Salt is Dissolved in Order to Obtain Alkoxysilane Compound

In Step (4), an aqueous layer in which the ammonium salt is dissolved is separated from an organic layer of the alkoxysilane compound, and removed to obtain a desired alkoxysilane compound.

As such, the alkoxysilane compound used for hydrophobic surface modification of a silica aerogel can be manufactured from the silazane-based compound using the method of manufacturing an alkoxysilane compound according to the present invention.

Specifically, according to one embodiment of the present invention, the silazane-based compound of Formula 1 can be hexamethyldisilazane, the alcohol can be ethanol, and the compound of Formula 2 can be trimethylchlorosilane.

When ethanol is added and reacted with the hexamethyldisilazane, a first mixture including trimethylethoxysilane and ammonia is prepared.

When ammonia included in the first mixture is reacted with the trimethylchlorosilane and the ethanol, a chloro of the trimethylchlorosilane is substituted with an ethoxy of the ethanol to generate additional trimethylethoxysilane, and ammonia is converted into ammonium chloride. In this way, in addition to the trimethylethoxysilane manufactured during the preparation of the first mixture, trimethylethoxysilane is further generated during preparation of the second mixture in the method of manufacturing an alkoxysilane compound according to one embodiment of the present invention. Therefore, the trimethylethoxysilane can be obtained with higher yield as compared to the reaction in which ethanol is added to hexamethyldisilazane to generate two molecules of trimethylethoxysilane as known in the related art. Also, an effect of converting ammonia, which is a by-product generated by the decomposition of the hexamethyldisilazane, into an ammonium salt in order to remove ammonia can be achieved as well.

Meanwhile, according to one embodiment of the present invention, the reaction of the alcohol with the silazane-based compound of Step (1) can be performed in the presence of an acid catalyst. The acid catalyst can be used to promote a reaction of the alcohol with the silazane-based compound. In this case, the acid catalyst can include one or more selected from the group consisting of nitric acid, hydrochloric acid, acetic acid, sulfuric acid, and hydrofluoric acid.

Hereinafter, exemplary embodiments of the present invention will be described in detail so that a person having ordinary skill in the art to which the present invention belongs can easily put the invention into practice. However, it should be understood that the present invention can be embodied in various forms and is not intended to limit the exemplary embodiments described herein.

### Example 1

A solution obtained by mixing hexamethyldisilazane (HMDS), ethanol, and HCl at a mole ratio of 1:2:0.00064 was stirred at room temperature for 2 hours to synthesize trimethylethoxysilane (TMES), and a concentration of ammonia in the synthesized trimethylethoxysilane (TMES) was measured. Then, trimethylchlorosilane (TMCS) and ethanol were added at the same equivalent(s) as the measured concentration of ammonia to generate a salt precipitate.

Distilled water was added to the generated trimethylethoxysilane at a volume ratio of 1:1, and stirred to dissolve the salt precipitate. Then, an aqueous layer was discarded to obtain trimethylethoxysilane (TMES) from which ammonia was removed.

### Example 2

Trimethylethoxysilane from which ammonia was removed was obtained in the same manner as in Example 1, except that hexamethyldisilazane and ethanol was mixed at a mole ratio of 1:2, and then reacted for 2 hours under a reflux condition at 75° C.

### Comparative Example 1

Hexamethyldisilazane and ethanol were mixed at a mole ratio of 1:2, and then reacted for 2 hours under a reflux condition at 75° C. to synthesize trimethylethoxysilane, and the synthesized trimethylethoxysilane was distilled to obtain trimethylethoxysilane.

### Comparative Example 2

Hexamethyldisilazane and ethanol were mixed at a mole ratio of 1:2, and then reacted for 2 hours under a reflux condition at 75° C. to synthesize trimethylethoxysilane, and the synthesized trimethylethoxysilane was further refluxed at 75° C. for 24 hours to obtain trimethylethoxysilane.

### Comparative Example 3

Hexamethyldisilazane and ethanol were mixed at a mole ratio of 1:2, and then reacted for 2 hours under a reflux condition at 75° C. to synthesize trimethylethoxysilane, and the synthesized trimethylethoxysilane was further refluxed at 75° C. for 24 hours, and then distilled to obtain trimethylethoxysilane.

### Experimental Example

1) Measurement of Ammonia Content

A content of ammonia in the trimethylethoxysilane and a content of ammonia remaining in the finally obtained trimethylethoxysilane were titrimetrically analyzed using sulfuric acid, and measured using 87 Titrino plus commercially available from Metrohm AG.

2) Yield

The yield of trimethylethoxysilane was calculated according to the following Mathematical Expression 1.

Yield (%)=(Number of moles of obtained trimethylethoxysilane/Number of moles of hexamethyldisilazane used×2)×100 [Mathematical Expression 1]

TABLE 1

| | | Content of | | | |
|---|---|---|---|---|---|
| | Reaction | ammonia in | Final content of | | |
| | temperature | TMES (% by | residual ammonia | | Manufacturing |
| | (° C.) | weight) | (% by weight) | Yield (%) | time (hr) |
| Example 1 | 25 | 2.5 | 0 | 110 | 5 |
| Example 2 | 75 | 0.9 | 0 | 103 | 5 |
| Comparative | 75 | 0.9 | 0.1 | 84 | 3 |
| Example 1 | | | | | |
| Comparative | 75 | 0.9 | 0.1 | 88 | 26 |
| Example 2 | | | | | |
| Comparative | 75 | 0.9 | 0.05 | 79 | 27 |
| Example 3 | | | | | |

As shown in Table 1, it can be seen that final residual ammonia was not observed in the case of Examples 1 and 2, but ammonia finally remained in the case of Comparative Examples 1 to 3, thereby confirming more effective removal of ammonia from the trimethylethoxysilane manufactured by the manufacturing method described in Examples 1 and 2. Also, in the case of Examples 1 and 2, because the yield of trimethylethoxysilane exceeded 100%, the trimethylethoxysilane was obtained at an amount greater than an amount of the trimethylethoxysilane obtained from the reacted hexamethyldisilazane. This was because the trimethylethoxysilane was additionally synthesized by the manufacturing method of Examples 1 and 2 by synthesizing trimethylethoxysilane (TMES), measuring a concentration of ammonia in the synthesized trimethylethoxysilane, and adding the trimethylchlorosilane (TMCS) and ethanol at the same equivalent(s) as the measured concentration of ammonia. Therefore, it can be seen that the manufacturing method of Examples 1 and 2 was very effective in removing ammonia and manufacturing an alkoxysilane compound because ammonia was very effectively removed by the manufacturing method of Examples 1 and 2 and the trimethylethoxysilane was additionally obtained using the ammonia to be removed. On the contrary, it can be seen that ammonia was discharged in the form of a gas and removed by distillation after the trimethylethoxysilane was synthesized through a reflux reaction of hexamethyldisilazane and ethanol in the case of Comparative Example 1, and ammonia was discharged in the form of a gas by further refluxing the synthesized trimethylethoxysilane in the case of Comparative Example 2, but the final remaining ammonia was included in the trimethylethoxysilane. In the case of Comparative Example 3, the synthesized trimethylethoxysilane was further refluxed and then re-distilled to further reduce a content of the final remaining ammonia, but ammonia finally remained in the trimethylethoxysilane, and loss of trimethylethoxysilane by the refluxing and distillation occurred.

In terms of the manufacturing time, a total of 5 hours was spent to manufacture the trimethylethoxysilane in the case of Examples 1 and 2, which was shorter than the manufacturing times of Comparative Examples 2 and 3 in which a total of 26 hours and a total of 27 hours were spent to manufacture the trimethylethoxysilane, respectively. In the case of Comparative Example 1, because only the synthesis and distillation of the trimethylethoxysilane were performed, the manufacturing time was only 3 hours in total, which was shorter than those of Examples 1 and 2. However, Comparative Example 1 had an inferior effect compared to Examples 1 and 2 in that the yield of trimethylethoxysilane was low and a large amount of ammonia finally remained in the trimethylethoxysilane.

1. A method of manufacturing an alkoxysilane compound, comprising:
(1) adding a first alcohol to a silazane-based compound of the following Formula 1 and allowing the alcohol to react with the silazane-based compound to prepare a first mixture comprising an alkoxysilane compound and ammonia;
(2) adding a second alcohol and a compound of the following Formula 2 to the first mixture and allowing the second alcohol and the compound of Formula 2 to react with the first mixture to prepare a second mixture in which an additional alkoxysilane compound and an ammonium salt are generated;
(3) adding an aqueous solvent to the second mixture to dissolve the ammonium salt; and
(4) separating and removing an aqueous layer in which the ammonium salt is dissolved in order to obtain an alkoxysilane compound: 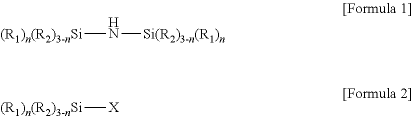
wherein R₁ is an alkyl group having 1 to 8 carbon atoms, R₂ is a hydrogen atom or an alkyl group having 1 to 8 carbon atoms, n is an integer ranging from 1 to 3, and X is Cl or Br.

2. The method of claim 1, wherein the silazane-based compound comprises one or more selected from the group consisting of a dialkyldisilazane, a tetraalkyldisilazane, and a hexaalkyldisilazane.

3. The method of claim 1, wherein the first alcohol and the second alcohol comprises one or more selected from the group consisting of methanol, ethanol, propanol, isopropanol, butanol, pentanol, hexanol, heptanol, octanol, glycerol, ethylene glycol, and dipropylene glycol.

4. The method of claim 1, wherein the alkoxysilane compound comprises one or more selected from the group consisting of a monoalkoxysilane compound, a dialkoxysilane compound, and a trialkoxysilane compound.

5. The method of claim 1, wherein each of the first alcohol and the second alcohol is a compound represented by of the following Formula 3, and the alkoxysilane compound is a compound represented by of the following Formula 4:
R₃OH [Formula 3]
(R₁)ₙ(R₂)₃₋ₙSi—O—R₃ [Formula 4]
wherein R₁ and R₃ are each independently an alkyl group having 1 to 8 carbon atoms, R₂ is a hydrogen atom or an alkyl group having 1 to 8 carbon atoms, and n is an integer ranging from 1 to 3.

6. The method of claim 1, wherein the compound of Formula 2 is added at the same equivalent(s) as ammonia in the first mixture.

7. The method of claim 1, comprising, before introducing the compound of Formula 2 into the first mixture:
measuring a concentration of ammonia included in the first mixture.

8. The method of claim 1, wherein the silazane-based compound is hexamethyldisilazane, the alcohol is ethanol, and the alkoxysilane is trimethylethoxysilane.

9. The method of claim 1, wherein the compound of Formula 2 is trimethylchlorosilane.

10. The method of claim 1, wherein the reaction of the alcohol with the silazane-based compound in Step (1) is performed in the presence of an acid catalyst.

11. The method of claim 10, wherein the acid catalyst comprises one or more selected from the group consisting of nitric acid, hydrochloric acid, acetic acid, sulfuric acid, and hydrofluoric acid.

12. The method of claim 1, wherein the first alcohol is the same as the second alcohol.

13. The method of claim 1, wherein the first alcohol is different from the second alcohol.
